(19) United States
(12) Patent Application Publication
(10) Pub. No.: US 2010/0025564 A1
(43) Pub. Date: Feb. 4, 2010

(54) Insert Fastening Apparatus

(75) Inventors: Peng He, Taipei Hsien (TW); Xiao-Ping Wu, Taipei Hsien (TW); Shih-Hsiung Ho, Taipei Hsien (TW)

Correspondence Address: WPAT, PC;INTELLECTUAL PROPERTY ATTORNEYS, 2030 MAIN STREET, SUITE 1300, IRVINE, CA, 92614, US

(73) Assignee: CHENG UEI PRECISION INDUSTRY CO., LTD., Taipei Hsien (TW)

(21) Appl. No.: 12/184,497

(22) Filed: Aug. 1, 2008

(51) Int. Cl. B29C 33/00

(52) U.S. Cl. 249/187.1

(57) ABSTRACT

An insert fastening apparatus adapted to fix an insert in an insert molding mold includes an upper module and a lower module. The upper module has an upper mating surface. The lower module has a lower mating surface defining at least one fastening groove thereon. The insert is arranged between the upper module and the lower module in the fastening groove. For the upper mating surface smoothly contacts the lower mating surface in a sealing engagement with the insert fixed in the fastening groove, the upper module and the lower module are not easy to be abraded or to form a gap and further prevent burrs formed on a finished product.

### BACKGROUND OF THE INVENTION

1. Field of the Invention

This present invention relates to an insert fastening apparatus, and more specifically to an insert fastening apparatus adapted to an insert molding mold.

2. The Related Art

Conventionally, in insert molding field, an insert fastening apparatus is used to fasten an insert and is placed on one side of a mold, a part of the insert is inserted into a mold cavity which is defined in the mold. When liquid plastic is injected into the mold cavity and become cold, the plastic and the insert are integrated with each other to form an expected product.

In order to manufacture a connector via an injecting mold, a plurality of terminals are fixed by an insert fastening apparatus fixed in the injecting mold, and parts of the terminals are arranged into a cavity formed in the injecting mold. When liquid plastic is injected into the cavity, the liquid plastic is easy to leak out from a gap formed between the terminals and the insert fastening apparatus, and some burrs are formed in surfaces of the expected connector.

### SUMMARY OF THE INVENTION

An object of the invention is to provide an insert fastening apparatus adapted to fix an insert into an insert molding mold. The insert fastening apparatus includes an upper module and a lower module. The upper module has an upper mating surface. The lower module has a lower mating surface matching the upper mating surface, at least one fastening groove is defined between the lower mating surface and the upper mating surface to fix a portion of the insert.

The upper mating surface smoothly contacts the lower mating surface in a sealing engagement with the portion of the insert fixed in the fastening groove, therefore, the upper module and the lower module are not easy to be abraded and to form gaps therebetween, so burrs will not be formed on a surface of the expected product during liquid plastic injecting.

### BRIEF DESCRIPTION OF THE DRAWINGS

The invention, together with its objects and the advantages thereof may be best understood by reference to the following description taken in conjunction with the accompanying drawings, in which:

FIG. 1 is a side perspective view of an insert fastening apparatus according to the present invention;

FIG. 2 is a perspective view of an upper module of the insert fastening apparatus;

FIG. 3 is a perspective view of a lower module of the insert fastening apparatus; and

FIG. 4 is a perspective view showing an embodiment of the present invention.

### DETAILED DESCRIPTION OF THE PREFERRED EMBODIMENT

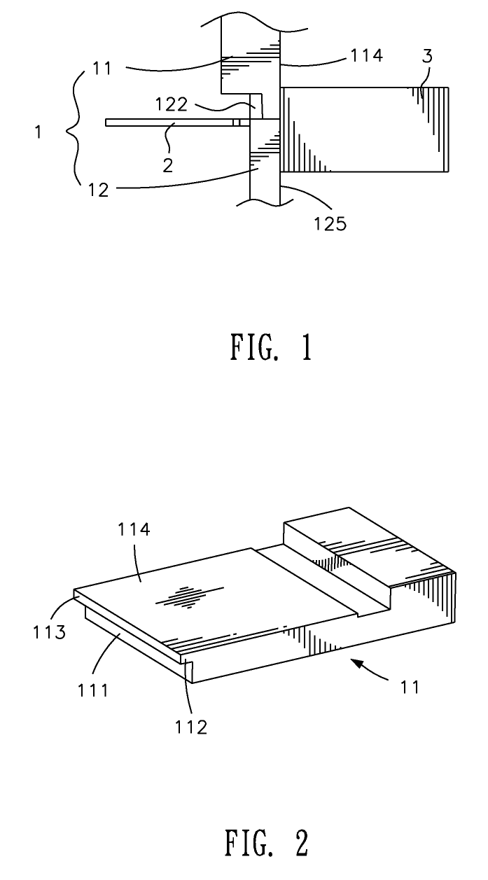

First referring to FIG. 1, an insert fastening apparatus 1 according to the invention is shown. The insert fastening apparatus 1 includes an upper module 11 and a lower module 12. The upper module 11 and the lower module 12 are arranged in an upper plate and a lower plate (not shown) of an insert molding mold respectively. The upper plate and the lower plate define a cavity (not shown) therebetween for molding a finished product by plastic injection and an insert 2 being integrated together.

Please referring to FIG. 2, the upper module 11 shows a rectangular board shape, an end of the upper module 11 has a base surface 111 showing a rectangular shape, one side of the base surface 111 projects to form a resisting portion 112, a tip end of the resisting portion 112 defines an upper mating surface 113. The upper module 11 has a first side 114 which is vertical to the upper mating surface 113 and adjacent to the cavity.

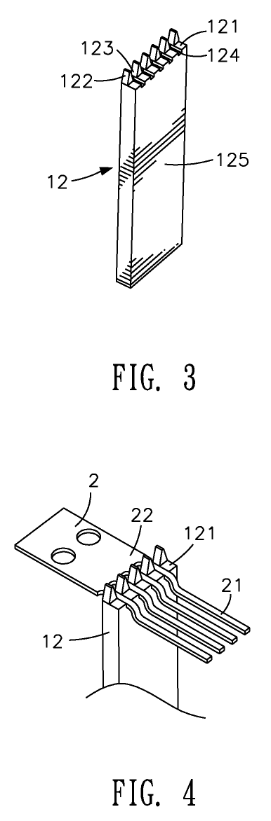

Referring to FIG. 3, the lower module 12 showing a rectangular board shape has a lower mating surface 121 at one end thereof, one side of the lower mating surface 121 projects upward to form a plurality of guiding portions 122 at intervals. Each of the guiding portions 122 shows a triangle body shape. The height of the guiding portion 122 is smaller than or equal to the height of the resisting portion 112. Adjacent two of the guiding portions 122 define a guiding groove 123 therebetween. The lower mating surface 121 dents to form a plurality of fastening grooves 124 which corresponds to and communicates with the guiding grooves 123 respectively. The lower module 12 has a second side 125 which is vertical to the lower mating surface 121 and adjacent to the cavity.

As shown in FIG. 4, in this embodiment, the insert 2 is a metal belt which has a plurality of terminals 21 parallel with each other. A connecting portion 22 of the insert 2 connects to ends of the terminals 21, the terminals 21 match the fastening grooves 124 respectively.

In inserting manufacture, firstly, the upper module 11 is separated with the lower module 12, the terminals 21 are arranged in the fastening grooves 124, front portions of the terminals 21 are placed in the cavity, the connecting portion 22 is located outside the upper module 11 and the lower module 12. Then, the upper module 11 and the lower module 12 are engaged with each other. Liquid plastic flows into the cavity to form a housing 3 integrated with the terminals 21, the upper mating surface 113 of the upper module 11 smoothly contacts the lower mating surface 121 of the lower module 12 in a sealing engagement with the terminals 21 fixed in the in the fastening grooves 124.

In practice, the guiding groove 123 and the fastening groove 124 can be changed to conform the shape of the terminal 21, and the amount of the guiding grooves 123 and the fastening grooves 124 match the amount of the terminals 21. The fastening grooves 124 can be arranged between the upper module 11 and the lower module 12, or in the upper module 11 only, or in the lower module 12 only.

As above description, the upper mating surface 113 smoothly contacts the lower mating surface 121 in a plane, the upper module 11 and the lower module 12 are not easy to be abraded and then form gaps therebetween, so burrs will not be formed in surfaces of the expected product.

An embodiment of the present invention has been discussed in detail. However, this embodiment is merely a specific example for clarifying the technical contents of the present invention and the present invention is not to be construed in a restricted sense as limited to this specific example. Thus, the spirit and scope of the present invention are limited only by the appended claims.

What is claimed is:

1. An insert fastening apparatus adapted to fix an insert in an insert molding mold, comprising:
an upper module having an upper mating surface; and
a lower module having a lower mating surface matching the upper mating surface, and at least one fastening groove being defined between the lower mating surface and the upper mating surface to fix a portion of the insert.

2. The insert fastening apparatus as set forth in claim 1, wherein the fastening groove is defined in the lower mating surface.

3. The insert fastening apparatus as set forth in claim 1, wherein the upper module has a resisting portion protruding from one end thereof, the upper mating surface being defined on the resisting portion.

4. The insert fastening apparatus as set forth in claim 3, wherein one side of the lower mating surface projects to form a plurality of guiding portions, a guiding groove being formed between adjacent two of the guiding portions and communicating with the fastening groove.

5. The insert fastening apparatus as set forth in claim 4, wherein the height of the guiding portion is equal to the height of the resisting portion.

6. The insert fastening apparatus as set forth in claim 4, wherein the height of the guiding portion is smaller than the height of the resisting portion.
